(19) United States
(12) Patent Application Publication
(10) Pub. No.: US 2017/0349153 A1
(43) Pub. Date: Dec. 7, 2017

(54) MOTOR DRIVE CONTROL UNIT

(71) Applicants: DENSO CORPORATION, Kariya-city, Aichi-pref. (JP); ADVICS CO., LTD., Kariya-city, Aichi-pref. (JP)

(72) Inventors: Hironobu YAMASHITA, Kariya-city, Aichi-pref. (JP); Takahiro YAMAGUCHI, Kariya-city, Aichi-pref. (JP); Kennji FUJIWARA, Kariya-city, Aichi-pref. (JP); Takashi MURAYAMA, Kariya-city, Aichi-pref. (JP); Keita NAKANO, Hamamatsu-shi, Shizuoka-ken (JP); Aritomo NABETA, Obu-shi, Aichi-ken (JP)

(21) Appl. No.: 15/539,072

(22) PCT Filed: Dec. 17, 2015
(86) PCT No.: PCT/JP2015/085360

§ 371 Date: Jun. 22, 2017

(30) Foreign Application Priority Data
Dec. 24, 2014 (JP) 2014-260860

(51) Int. Cl. B60T 8/48; H02P 1/18

(52) U.S. Cl. CPC B60T 8/48; H02P 1/18

(57) ABSTRACT

An increase in startup current supplied to a motor is suppressed at an initial stage of starting automatic braking control, while current supply to the motor is performed in a fully energized state after the automatic braking control is started. While output of the motor is increased by controlling the motor in the fully energized state so that a high braking force with high responsiveness is obtained, startup current is prevented from becoming excessive by performing high frequency control only at startup. Thus, decrease in battery voltage is minimized and thus the occurrence of malfunction is minimized in the control systems of various electrical components used in the vehicle.

### TECHNICAL FIELD

The present invention relates to a motor drive control unit applied to driving of a motor for driving a pump which is provided to a vehicle braking device.

### BACKGROUND ART

Vehicle braking devices based on conventional art include a pump and a motor for driving the pump. The pump charges a brake fluid from a master cylinder (hereinafter referred to as M/C) side and discharges the brake fluid to a wheel cylinder (hereinafter referred to as W/C) side. Such a conventional vehicle braking device is configured to automatically generate a braking force. Specifically, such a conventional vehicle braking device generates a W/C pressure by driving the pump with use of the motor and automatically generates a braking force. Therefore, it has been desired to improve responsiveness so that a braking force is secured in a shorter period as urgency is higher when automatic braking for automatically generating a braking force is applied.

For example, in the conventional vehicle braking device, automatic braking is applied if it is determined that a front obstacle is present, based on identification information which is supplied from a sensor or the like used for identifying the front obstacle. In this case, primary braking in which a brake force is increased with a comparatively slight increase gradient is applied at an initial stage of the automatic braking, and then secondary braking in which a braking force is increased with a comparatively steep increase gradient is applied. If an obstacle suddenly appears in front of and relatively near the vehicle from a direction lateral to the traveling direction of the vehicle, rather than approaching from a distance, a braking force needs to be increased with a steeper increase gradient than the increase gradient of the conventional secondary braking. However, the conventional vehicle braking device cannot generate a braking force in a shorter period and thus cannot provide high responsiveness.

To address such a disadvantage, Patent Literature 1 proposes a motor control apparatus enabling a vehicle braking device to achieve higher responsiveness. According to this motor control apparatus, while supply of the driving current (motor current) to the motor is suppressed by performing high frequency control such as PWM control, the duty ratio is set higher at the initial stage of starting automatic braking control than in the subsequent steady state that is after generation of a predetermined braking force. This makes it possible to increase a braking force with a steep increase gradient at the initial stage in which automatic braking control is started with high duty ratio, thereby enabling generation of a braking force in a shorter period.

### CITATION LIST

### Patent Literature

[PTL 1] JP 2009-131128 A

### SUMMARY OF THE INVENTION

### Technical Problem

According to the technique of causing duty ratio to be high only at the initial stage of starting automatic braking control while suppressing duty ratio in a steady state as in the invention disclosed in Patent Literature 1, it is true that responsiveness at the initial stage can be obtained, but a high braking force with high responsiveness cannot be obtained. That is, if high responsiveness is merely required to be obtained, duty ratio has to be high only at the initial stage of starting automatic braking control as with the invention of Patent Literature 1. However, since this is based on the premise of suppressing duty ratio in a steady state, a high braking force cannot be obtained.

To obtain a higher braking force while securing high responsiveness, it is necessary to control motor current so as to achieve a fully energized state in which the motor is driven by being continuously supplied with a motor current, instead of controlling motor current by performing only high frequency control. However, in the case where the motor is driven in a fully energized state, a startup current (motor current at startup) increases at the initial stage of starting automatic braking control. This causes a decrease in voltage of a battery which supplies current to the motor. This may consequently cause malfunction in the control systems of various electrical components used in the vehicle. The decrease in voltage of the battery caused by the increase in startup current depends on the state or temperature of the battery. It is therefore difficult to accurately estimate a decrease in voltage of the battery without taking account of these factors.

In view of the foregoing points, an object of the present invention is to provide a motor drive control unit capable of suppressing, at an initial stage of starting automatic braking control, an increase in startup current supplied to a motor, while supplying current to the motor for full energization after the automatic braking control is started.

### Solution to Problem

To attain the object, a motor drive control unit recited in claim 1 includes a switching element (62, 63), and control means (70). The switching element is provided in a supply path through which a motor current is passed from a power source (61) to the motor (60) to control on/off switching of the supply path. The control means performs motor control in which current supply to the motor is controlled by controlling on/off switching of the switching element, and includes startup control means (320) and normal control means (370). The startup control means performs high frequency control with respect to the switching element at startup when current supply to the motor is started to apply automatic braking. The normal control means continuously turns on the switching element after the high frequency control is performed at the startup, and achieves a fully energized state in which current supply to the motor is continuously performed.

### Advantageous Effects of the Invention

As described above, while output of the motor is increased by controlling the motor in the fully energized state so that a high braking force with high responsiveness is obtained, a startup current is prevented from becoming excessive by performing the high frequency control only at startup. Thus, decrease in battery voltage is minimized and thus the occurrence of malfunction is minimized in the control systems of various electrical components used in the vehicle.

Note that the reference sign in parentheses for the each means indicates an example of correspondence with the specific means in an embodiment described later.

### BRIEF DESCRIPTION OF THE DRAWINGS

FIG. 1 is a view illustrating a hydraulic circuit configuration of a vehicle braking device including a motor drive control unit according to a first embodiment of the present invention.

FIG. 2 is a view illustrating a circuit configuration of a drive circuit of a motor 60.

FIG. 3 is a view illustrating a state where an obstacle 82 is present in an identification range 81 in front of a vehicle 80.

FIG. 4 is a flow chart showing automatic braking control performed in the case where the obstacle 82 is present relatively far from the vehicle 80.

FIG. 5 is a view showing a relationship between a relative distance from the vehicle 80 to the obstacle 82 and a period until the vehicle 80 reaches the obstacle 82.

FIG. 6 is a time chart showing a change in braking force when the automatic braking control shown in FIG. 4 is performed.

FIG. 7 is a flow chart showing automatic braking control performed when the obstacle 82 has suddenly appeared near the vehicle 80.

FIG. 8 is a time chart showing a change in braking force when the automatic braking control shown in FIG. 7 is performed.

FIG. 9 is a flow chart showing a startup program for emergency braking.

FIG. 10 is a view showing a relationship between battery voltage and motor current.

FIG. 11 is a time chart showing the case where motor control described in the first embodiment is performed.

### DESCRIPTION OF THE EMBODIMENTS

The following description will discuss embodiments of the present invention with reference to the drawings. In the embodiments described below, the same or equivalent parts are given identical reference signs.

### First Embodiment

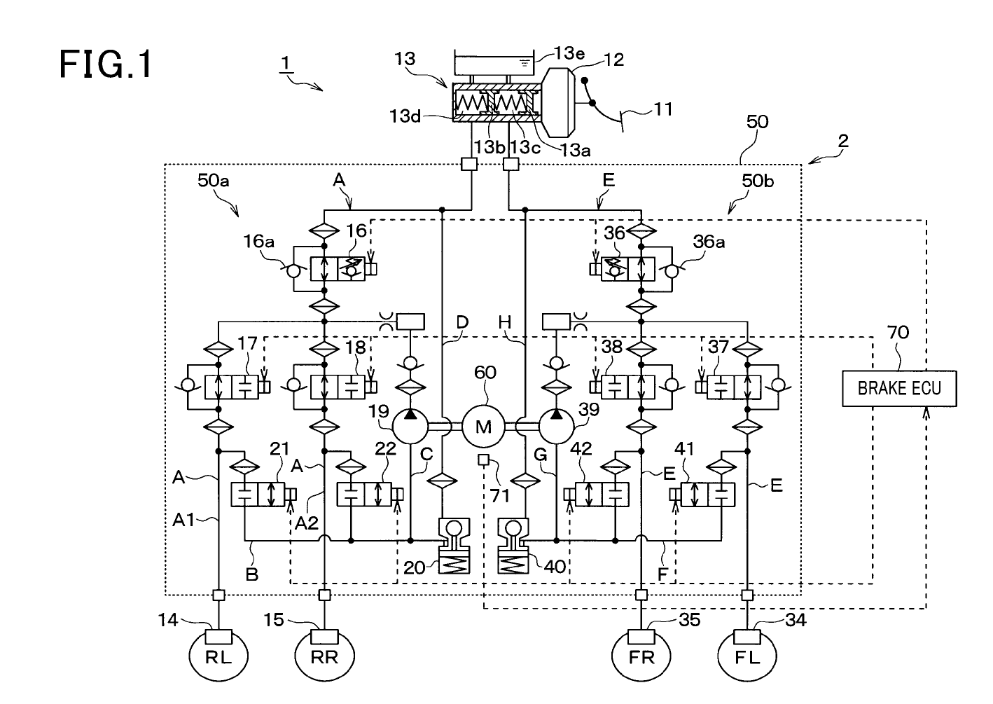

The following description will discuss an embodiment of the present invention shown in the drawings. The following discusses a vehicle braking device including a motor drive control unit according to an embodiment of the present invention. FIG. 1 is a hydraulic circuit diagram illustrating a basic configuration of a vehicle braking device 1 according to the present embodiment. The first embodiment describes, as an example, a vehicle equipped with a hydraulic circuit for front and rear piping. However, the vehicle can be equipped with, for example, X-type piping.

As illustrated in FIG. 1, a brake pedal 11 which is a brake operation member to be operated by a driver is connected via a brake booster 12 to an M/C 13 which is a source of brake fluid pressure. When the brake pedal 11 is depressed, a depressing force is boosted by the brake booster 12 and then master pistons 13a and 13b provided in the M/C 13 are depressed by the depressing force thus boosted. This causes the same M/C pressure to be generated in each of a primary chamber 13c and a secondary chamber 13d which are defined by the master pistons 13a and 13b. The M/C pressure is then transmitted to each of W/Cs 14, 15, 34, and 35 through a brake fluid pressure control actuator 50. The M/C 13 includes a master reservoir 13e having paths for communication with the primary chamber 13c and the secondary chamber 13d.

The brake fluid pressure control actuator 50 is configured by a first piping system 50a and a second piping system 50b and includes a block, not illustrated, which is made of aluminum or the like and in which brake piping is formed, with various components assembled for integration. The first piping system 50a is a rear system which controls a brake fluid pressure applied to a left rear wheel RL and a right rear wheel RR. The second piping system 50b is a front system which controls a brake fluid pressure applied to a left front wheel FL and a right front wheel FR.

The first and second piping systems 50a and 50b have similar basic structures. The following description will therefore deal with the first piping system 50a, and description of the second piping system 50b will be omitted.

The first piping system 50a includes a pipeline A which serves as a main pipeline and through which the M/C pressure described above is transmitted to the W/C 14 provided in the left rear wheel RL and the W/C 15 provided in the right rear wheel RR so that a W/C pressure is generated.

The pipeline A is provided with a first differential pressure control valve 16. The pipeline A is controlled to be in a communicating state or a differential pressure state by the first differential pressure control valve 16 which controls a differential pressure between a first pipeline on the M/C 13 side which is an upstream side and a second pipeline on the W/Cs 14 and 15 side which is a downstream side. In the first differential pressure control valve 16, the valve position is adjusted such that the first differential pressure control valve 16 is brought into the communicating state during normal braking in which the driver operates the brake pedal 11 (i.e., when neither automatic braking control, such as collision avoidance, nor vehicle motion control, such as skid prevention control, is performed). When current is caused to flow through a solenoid coil provided in the first differential pressure control valve 16, the valve position of the first differential pressure control valve 16 is adjusted such that the first differential pressure control valve 16 is brought into the differential pressure state in which the differential pressure becomes larger as larger current is caused to flow.

In the case where the first differential pressure control valve 16 is in the differential pressure state, the brake fluid can flow from the W/Cs 14 and 15 side to the M/C 13 side only when the brake fluid pressure on the W/Cs 14 and 15 side is higher than the M/C pressure by not less than a predetermined value. Accordingly, the brake fluid pressure on the W/Cs 14 and 15 side is always maintained so as not to be higher than the M/C pressure on the M/C 13 side by more than the predetermined value. Furthermore, a check valve 16a is provided in parallel to the first differential pressure control valve 16.

The pipeline A branches into two pipelines A1 and A2 on the W/Cs 14 and 15 side which is a downstream side of the first differential pressure control valve 16. The pipeline A1 is provided with a first pressure increase control valve 17 which controls an increase in brake fluid pressure applied to the W/C 14. The pipeline A2 includes a second pressure increase control valve 18 which controls an increase in brake fluid pressure applied to the W/C 15.

The first and second pressure increase control valves 17 and 18 are each constituted by a normally open two-position double solenoid valve capable of controlling a communicating state and a non-communicating state. Specifically, in a state where control current applied to solenoid coils of the respective first and second pressure increase control valves 17 and 18 is zero (i.e., in a state where the solenoid coils are not energized), the first and second pressure increase control valves 17 and 18 are controlled to be in the communicating state. In a state where control current is applied to the solenoid coils of the respective first and second pressure increase control valves 17 and 18 (i.e., in a state where the solenoid coils are energized), the first and second pressure increase control valves 17 and 18 are controlled to be in the non-communicating state.

The rear system also includes a pipeline B serving as a decompression pipeline to connect a pressure regulator reservoir 20 to a point between the first pressure increase control valve 17 and the W/C 14, and to a point between the second pressure increase control valve 18 and the W/C 15 in the pipeline A. The pipeline B includes a first pressure reduction control valve 21 and a second pressure reduction control valve 22. The first and second pressure reduction control valves 21 and 22 are each constituted by a normally closed two-position double solenoid valve capable of controlling a communicating state and a non-communicating state. Specifically, in a state where control current applied to solenoid coils of the respective first and second pressure reduction control valves 21 and 22 is zero (i.e., in a state where the solenoid coils are not energized), the first and second pressure reduction control valves 21 and 22 are controlled to be in the non-communicating state. In a state where control current is applied to the solenoid coils of the respective first and second pressure reduction control valves 21 and 22 (i.e., in a state where the solenoid coils are energized), the first and second pressure reduction control valves 21 and 22 are controlled to be in the communicating state.

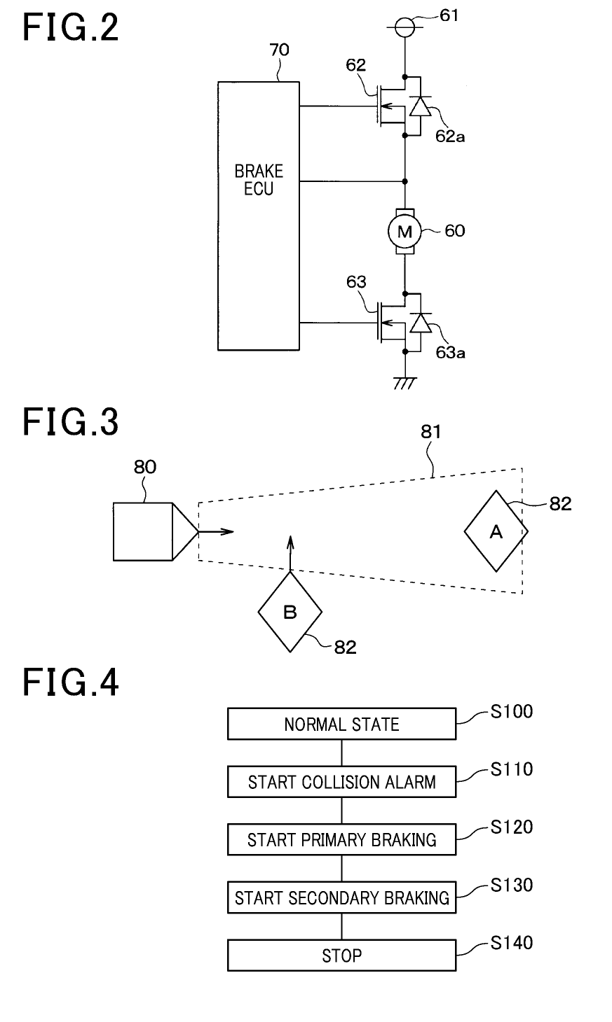

A pipeline C serving as a reflux pipeline is provided between the pressure regulator reservoir 20 and the pipeline A serving as the main pipeline. The pipeline C is provided with a self-sucking pump 19 that is driven by a motor 60 to charge the brake fluid from the pressure regulator reservoir 20 and discharge the brake fluid towards the M/C 13 or the W/Cs 14 and 15. The motor 60 is driven with the energization controlled by a drive circuit illustrated in FIG. 2. A configuration of the drive circuit of the motor 60 will be described later.

A pipeline D serving as an auxiliary pipeline is provided between the pressure regulator reservoir 20 and the M/C 13. Through the pipeline D, the pump 19 charges the brake fluid from the M/C 13 and discharges the brake fluid to the pipeline A. In this manner, when vehicle motion control is performed, the brake fluid is supplied to the W/Cs 14 and 15 side so that the W/C pressure of a target wheel is increased.

The foregoing description has dealt with the first piping system 50a. The second piping system 50b is similar in configuration to the first piping system 50a and includes components similar to those of the first piping system 50a. Specifically, the second piping system 50b includes a second differential pressure control valve 36 and a check valve 36a corresponding to the first differential pressure control valve 16 and the check valve 16a, respectively. The second piping system 50b includes a third pressure increase control valve 37 and a fourth pressure increase control valve 38 corresponding to the first and second pressure increase control valves 17 and 18, respectively. The second piping system 50b includes a third pressure reduction control valve 41 and a fourth pressure reduction control valve 42 corresponding to the first and second pressure reduction control valves 21 and 22, respectively. The second piping system 50b includes a pump 39 corresponding to the pump 19 and a pressure regulator reservoir 40 corresponding to the pressure regulator reservoir 20. The second piping system 50b further includes pipelines E to H corresponding to the pipelines A to D, respectively. Note, however, that the first piping system 50a and the second piping system 50b may differ from each other such that the W/Cs 34 and 35 of the second piping system 50b that serves as the front system and supplies the brake fluid to the W/Cs 34 and 35 are larger in capacity than the W/Cs 14 and 15 of the first piping system 50a that serves as the rear system and supplies the brake fluid to the W/Cs 14 and 15. In the case where the first and second piping systems 50a and 50b are thus configured, a larger braking force can be generated on the front side.

The vehicle braking device 1 further includes an electronic control unit for braking control (hereinafter referred to as brake ECU) 70 corresponding to control means. The brake ECU 70 is constituted by a microcomputer including CPU, ROM, RAM, I/O, and the like. The brake ECU 70 performs a process, including various calculations, according to a program stored in the ROM or the like, and performs braking control, including automatic braking control and various types of vehicle motion control. For example, an obstacle detection device, or, for example, the brake ECU 70 uses as a basis detection signals supplied from other sensors, such as an obstacle sensor, to calculate various physical values occurring in the vehicle, a deceleration necessary for avoiding collision with an obstacle, and the like. Various components of the brake fluid pressure control actuator 50 are controlled based on the results of the calculations, so that the automatic braking control is performed to generate a braking force equivalent to a desired deceleration for a controlled wheel, or that the vehicle motion control is performed.

Referring to FIG. 2, the following description will discuss a configuration of a drive control apparatus of the motor 60. FIG. 2 illustrates a circuit configuration of the drive control apparatus of the motor 60. The drive control apparatus is constituted by a part of the brake ECU 70 which part controls the circuit configuration illustrated in FIG. 2 and by the circuit illustrated in FIG. 2.

As illustrated in FIG. 2, in a supply path of a motor current supplied from a battery 61 which is a power source, switching elements 62 and 63 which control on/off switching of the supply path are connected in parallel to a diode 62a on an upstream side of the motor 60 and a diode 63a on a downstream side of the motor 60, respectively. In this manner, the basic circuit of the drive circuit of the motor 60 is configured. The switching elements 62 and 63 are driven based on a control signal supplied from the brake ECU 70. When both of the switching elements 62 and 63 are turned on, current is supplied from the battery 61 to the motor 60 so that the motor 60 is driven.

The brake ECU 70 carries out an operation for performing various types of brake fluid pressure control, including automatic braking control and various types of vehicle motion control. Accordingly, the brake ECU 70 recognizes the fact that one of the various types of brake fluid pressure control has been started and also recognizes various control variables of the brake fluid pressure control. The brake ECU 70 therefore drives various control valves or drives the motor 60 on the basis of a request from the brake fluid pressure control thus performed to operate the pumps 19 and 39 so as to charge and discharge the brake fluid.

In this case, the motor current can be controlled by performing high frequency switching with respect to one of the switching elements 62 and 63 by performing high frequency control, such as PWM control, while the other one of the switching elements 62 and 63 is turned on. Thus, motor control can be performed in both of a control mode in which the motor current is supplied for achieving a fully energized state by continuously turning on both of the switching elements 62 and 63 and a control mode in which the high frequency control is performed with respect to the motor current by performing high-speed switching. According to these control modes of motor control, the amount of a brake fluid to be discharged by the pumps 19 and 39 can be adjusted according to a control request value, thereby achieving desired brake fluid pressure control.

In the case of performing high frequency switching with respect to the switching elements 62 and 63, another element, such as a reflux diode for absorbing switching surges, can be connected in parallel to the motor 60. Since such an element is common, it is omitted from FIG. 2.

As illustrated in FIG. 2, a terminal voltage, i.e., a battery voltage, on the upstream side of the motor 60 in the motor drive circuit is inputted to the brake ECU 70. This allows the brake ECU 70 to monitor the battery voltage as one of vehicle conditions. As illustrated in FIG. 2, the motor 60 includes a temperature sensor 71 as rotation speed correction means, so that a motor temperature can be detected through the temperature sensor 71.

The vehicle braking device 1 including the motor drive control unit according to the present embodiment is configured as described above. The following description will discuss an example of an operation conducted by the vehicle braking device 1 having such a configuration. The present embodiment is characterized by automatic braking control for avoiding collision with an obstacle when the obstacle is detected on the basis of a detection signal supplied from an obstacle sensor, not illustrated. In the present embodiment, the normal braking operation of the driver depressing a brake pedal and various types of vehicle motion control, such as skid prevention control, for stabilizing the vehicle are similar to those of a conventional technique. Therefore, only the automatic braking control is described herein.

As illustrated in FIG. 3, when an obstacle 82 is detected ahead of a vehicle 80 during traveling, based on a detection signal supplied from an obstacle sensor, automatic braking control is performed according to the distance to the obstacle 82. For example, in the case where the distance from the vehicle 80 to the obstacle 82 is long and urgency is not high, such as the case where, as illustrated in FIG. 3, the obstacle 82 has stopped at a position A in an identification range 81 of the obstacle sensor, automatic braking control is performed in a control mode similar to a conventional control mode.

Specifically, as shown in FIG. 4, until the obstacle 82 is detected, the vehicle 80 is in a normal state shown in step 100. That is, until then, the vehicle 80 is in a state where braking control can be performed in response to depression of the brake pedal by the driver or braking control can be performed in response to a request from vehicle motion control, such as skid prevention control. If the obstacle 82 is detected in this state, a process of starting a collision alarm is performed in step 110 and the brake ECU 70 instructs an alarm section, not illustrated, to issue a collision alarm. The alarm section can be a display or an alarm lamp which visually notifies the driver of a collision risk, or can be a voice guidance device which audibly notifies the driver of a collision risk. With use of the alarm section, the driver is notified that the obstacle 82 is present in front of the vehicle and there is a collision risk.

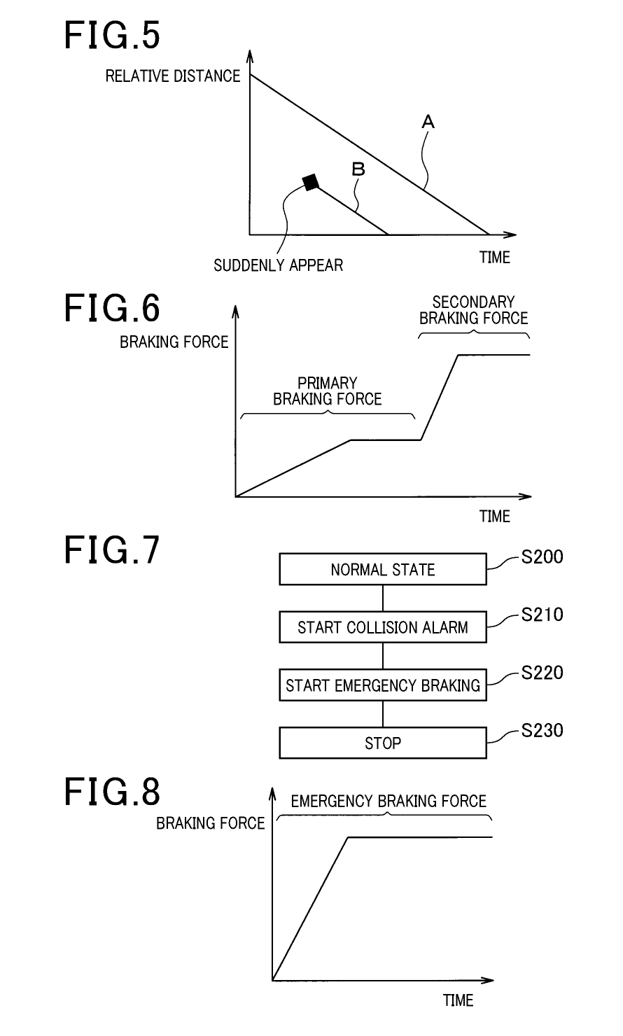

The process then proceeds to step 120 and the ECU 70 applies primary braking at an initial stage of automatic braking to increase the braking force with a comparatively slight increase gradient. The process then proceeds to step 130 and the ECU 70 applies secondary braking to increase the braking force with a comparatively steep increase gradient. That is, as illustrated in FIG. 5, in the case where no automatic braking control is performed, a relative distance from the own vehicle to the obstacle 82 is long and thus it takes a relatively long time until the own vehicle collides with the obstacle 82. As illustrated in FIG. 6, therefore, collision with the obstacle 82 can be avoided by increasing the braking force with a comparatively slight increase gradient as in the primary braking and then generating a desired braking force with a comparatively steep increase gradient as in the secondary braking.

Subsequently, when the vehicle stops, with the secondary braking being applied until then, the automatic braking control is terminated, as shown in step 140.

In the case where the obstacle 82 is present at a position B illustrated in FIG. 3, that is, for example, in the case where the obstacle 82 enters the identification range 81 of the obstacle sensor from a direction lateral to the traveling direction of the vehicle, the distance from the own vehicle to the obstacle 82 is short and urgency is high. In such a case, the ECU 70 performs automatic braking control with high responsiveness so that a desired braking force is generated in a shorter period.

Specifically, as shown in FIG. 7, in the case where an obstacle is detected while the vehicle 80 is in a normal state as in step 200 and the distance to the obstacle is short and thus high responsiveness is required, the following process is performed. First, in step 210, a process of starting a collision alarm is performed as in step 110 shown in FIG. 4 to notify the driver that the obstacle is present in front of the vehicle and there is a collision risk.

The process then proceeds to step 220 and an instruction for starting emergency braking is issued. This causes, as shown in FIG. 8, a braking force with a steep increase gradient to be generated from the initial stage of starting automatic braking. The increase gradient in this case is set to be steeper than the increase gradient at the time of applying the secondary braking described above. That is, in the case where the obstacle 82 is present at the position B and no automatic braking control is performed, as illustrated in FIG. 5, the relative distance from the own vehicle to the obstacle is short and thus it takes a shorter period until the own vehicle collides with the obstacle. Therefore, unless a braking force is generated with a steep increase gradient as shown in FIG. 8, collision with the obstacle cannot be avoided. Thus, a braking force is ensured to be generated with a steep increase gradient so that a collision with the obstacle can be avoided even if the distance from the vehicle to the obstacle is short.

Subsequently, when the vehicle stops, with the secondary braking being applied until then, the automatic braking control is terminated as shown in step 230.

However, to generate a braking force with a steep increase gradient as described above, the motor 60 needs to be started with high responsiveness. If the motor current is increased with a steep increase gradient for full energization of the motor to achieve high responsiveness, the startup current unavoidably increases and this leads to a decrease in battery voltage. This may cause malfunction in the control systems of various electrical components used in the vehicle.

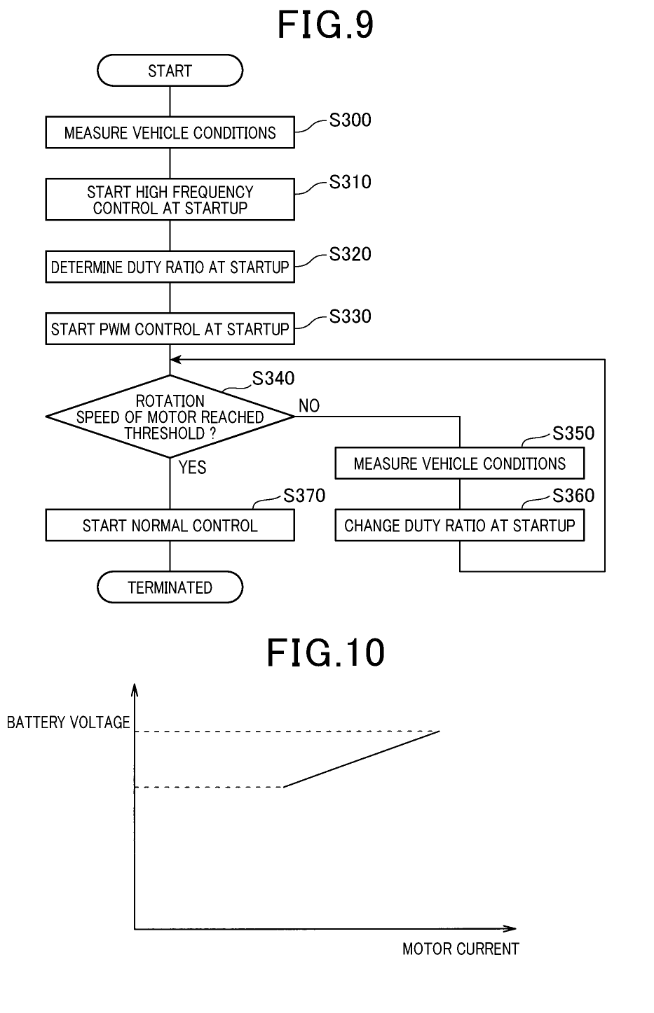

According to the present embodiment, therefore, after the instruction for starting the emergency braking is issued as shown in step 220 and until the vehicle stops in step 230, various processes of a startup program for emergency braking shown in FIG. 9 are performed.

Specifically, in step 300, the vehicle conditions are measured, and then in step 310, high frequency control for startup is started according to the vehicle conditions thus measured.

The “vehicle conditions” refers to the battery voltage or the temperature of the motor. A decrease in battery voltage to not more than a predetermined voltage may cause malfunction in the control systems of the various electrical components used in the vehicle. The resistance of a motor coil depends on the temperature of the motor, specifically, the temperature of the motor coil, leading to a change in the rotation speed of the motor when the motor current is constant. For these reasons, the battery voltage and the temperature of the motor are measured as the vehicle conditions.

In step 320, the high frequency control of repeatedly turning on/off switching the motor by PWM control is performed as startup motor control, and a duty ratio (ratio of on time in a predetermined period) in the PWM control is determined. For example, as shown in FIG. 10, duty ratio is changed according to the battery voltage so as to be decreased as the battery voltage decreases. In this manner, the battery voltage is prevented from being abnormally decreased by the increase in the startup current.

The process then proceeds to step 330 and the PWM control is started as the startup motor control determined in step 320. Since the high frequency control based on the PWM control is performed at the startup in this manner, while the motor current is increased with a steep increase gradient at the start of increasing the motor current, the increase gradient can be suppressed to prevent an abnormal decrease of the battery voltage by the excessive startup current. Since the duty ratio in the PWM control is set according to the battery voltage, the motor current is increased with a predetermined increase gradient according to the change in the battery voltage.

Subsequently, the process proceeds to step 340 where it is determined whether the rotation speed of the motor 60 has reached a threshold. The threshold is set to a rotation speed which does not exceed an allowable upper limit of the motor current. With the threshold being set to a value less than an allowable upper limit, the battery voltage is prevented from decreasing to a level so low as to cause malfunction in the control systems of other various electrical components used in the vehicle, even if the startup current increases when control of the motor 60 is switched from the high frequency control to fully-energized-state control. That is, if the rotation speed of the motor 60 is insufficient and the control of the motor 60 is switched from the high frequency control to the fully-energized-state control, the startup current starts increasing and unavoidably reaches the allowable upper limit. Therefore, by determining, in step 340, whether the rotation speed of the motor 60 has reached the threshold, the battery voltage is prevented from being decreased by the switching of the control of the motor 60 to the fully-energized-state control.

The rotation speed of the motor 60 can be estimated by performing an operation based on the driving voltage (battery voltage in the present embodiment) applied to the motor 60 and the time elapsed from the start of current supply. Since the resistance of the motor coil depends on the temperature of the motor coil, the rotation speed of the motor 60 can be more precisely calculated by calculating the resistance of the motor coil on the basis of the detection result of the temperature sensor 71 described above, and then correcting the rotation speed of the motor 60 according to the change in resistance of the motor coil.

As a matter of course, the motor 60 may include a rotation speed sensor and the rotation speed of the motor 60 may be directly measured based on the detection result of the rotation speed sensor. When the motor 60 is provided with a brush, torque ripple is caused in the motor current with the rotation of the motor 60. Accordingly, the rotation speed of the motor 60 can be calculated based on the torque ripple.

If a negative determination is made in step 340, the rotation speed of the motor 60 is still insufficient. In such a case, the process proceeds to step 350 and the vehicle conditions are measured again. Subsequently, the process proceeds to step 360 where the duty ratio is changed as necessary by resetting the duty ratio in the PWM control performed at the startup, based on the result of the measurement in step 350. For example, as shown in FIG. 10, if the battery voltage decreases, the duty ratio is changed, for example decreased, to prevent abnormal decrease of the battery voltage.

After the duty ratio in the PWM control is reset as described above, step 340 is repeated. If an affirmative determination is made in step 340, the process proceeds to step 370. In this case, since the rotation speed of the motor 60 is sufficient, control of supplying a motor current for achieving a fully energized state is started as normal control.

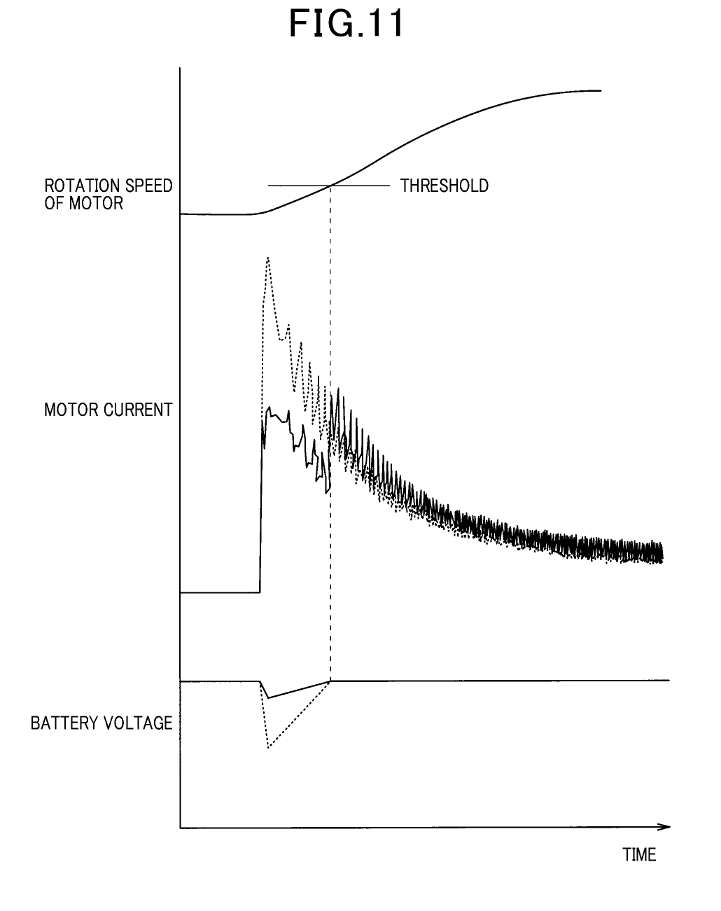

FIG. 11 is a time chart showing the motor control described above. In addition to the motor current (indicated by the solid line) flowing when the motor control is performed, FIG. 11 shows, for reference, motor current (indicated by the dashed line) flowing when fully-energized-state control is performed from the startup of the motor 60. FIG. 11 shows, as an example, the case where the motor 60 includes a brush. Accordingly, in this example, a torque ripple is caused in the motor current that is a change other than the change due to the high frequency control. The torque ripple, therefore, is not due to the high frequency control. The battery voltage in an actual vehicle presumably has a wave form different than shown in FIG. 11 due to other factors, such as electrical charging caused by the start of an alternator. However, such other factors are disregarded in FIG. 11.

If the motor 60 is controlled in the fully energized state from the startup, the motor current can be increased with a steep increase gradient as indicated by the dashed line in FIG. 11, but the startup current also increases and reaches an allowable upper limit, leading to a decrease in battery voltage.

According to the present embodiment, the high frequency control based on the PWM control is performed at the startup of the motor 60. Therefore, as indicated by the solid line in FIG. 11, increase in startup current can be suppressed, while the motor current is increased with a steep increase gradient. Thus, lowering of the battery voltage is minimized.

If the rotation speed of the motor 60 exceeds the threshold, control of the motor 60 is switched from the high frequency control to the fully-energized-state control. Although this may increase the motor current to some extent, even in such a case, the increase in motor current neither causes the motor current to reach the allowable upper limit nor causes the battery voltage to decrease.

As has been described, according to the present embodiment, output of the motor 60 is increased by controlling the motor 60 in the fully energized state, so that a high braking force with high responsiveness is obtained. Furthermore, the startup current is prevented from becoming excessive by performing the high frequency control only at the startup. Accordingly, decrease in battery voltage is prevented and thus malfunction is prevented from occurring in the control systems of the various electrical components used in the vehicle.

### Other Embodiments

The present invention is not limited to the embodiment described above, but can be altered as appropriate within the scope of the claims.

For example, according to the above embodiment, by comparing the rotation speed of the motor 60 with the threshold in step 340, it is determined whether an increase in startup current can be prevented. Alternatively, it can be configured such that an increase in the amount of a startup current is calculated on the basis of the rotation speed of the motor 60, and then the control of the motor 60 is switched from the high frequency control to the fully-energized-state control if the startup current thus calculated is not more than the allowable upper limit. That is, a counter-electromotive force of the motor 60 can be calculated from the rotation speed of the motor 60, and based on the counter-electromotive force, an increase in the amount of the motor current can be calculated for the case where the control of the motor 60 is switched to the fully-energized-state control. Then, the startup current after the switching can be calculated from the increase in the amount of the motor current. It may therefore be only necessary to determine whether the startup current is not more than the allowable upper limit.

The above embodiment deals with an example in which the switching elements 62 and 63 are provided upstream and downstream of the motor 60, respectively. However, switching element does not need to be provided both upstream and downstream of the motor 60 but may be provided either upstream or downstream, and control of the switching element may be switched from the high frequency control to the fully-energized-state control. Furthermore, in the case of providing the switching elements 62 and 63 upstream and downstream of the motor 60, respectively, the high frequency control can be performed for either one of the switching elements 62 and 63.

According to the above embodiment, the duty ratio is set according to the battery voltage, but may instead be set according to the motor temperature, or according to both the motor temperature and the battery voltage. When the motor temperature is low, the resistance of the motor coil becomes low, and this tends to increase an inrush current. In the state where the motor temperature is low, the battery temperature is also expected to be low and thus charging/discharging capability of the battery is expected to be lowered as well. Therefore, by creating a setting where lower temperature causes lower duty ratio, the battery voltage can be prevented from being decreased by the increase in inrush current at the startup.

The steps shown in the drawings correspond to respective means for performing various processes. That is, the parts performing the processes in step 320, 330, and 370 correspond to the startup control means, the determination means, and the normal control means, respectively.

### REFERENCE SIGNS LIST

1: Vehicle braking device; 19, 39: Pump; 60: Motor; 61: Battery; 62, 63: Switching element; 70: Brake ECU; 80: Vehicle; 81: Identification range; 82: Obstacle

1. A motor drive control unit that controls driving of a motor provided in a vehicle braking device to drive a pump arranged in a hydraulic circuit of the vehicle braking device, the vehicle braking device applying automatic braking by charging and discharging a brake fluid to generate a wheel cylinder pressure in a wheel cylinder, the motor drive control unit comprising:
a switching element provided in a supply path through which a motor current is passed from a power source to the motor to control on/off switching of the supply path; and
control means performing motor control in which current supply to the motor is controlled by controlling on/off switching of the switching element,
the control means including:
startup control means performing high frequency control with respect to the switching element at startup when current supply to the motor is started to apply automatic braking; and
normal control means continuously turning on the switching element after the high frequency control is performed at the startup, and achieving a fully energized state in which current supply to the motor is continuously performed.

2. The motor drive control unit according to claim 1, wherein the control means includes determination means determining whether a rotation speed of the motor has reached a predetermined threshold, and switching the high frequency control performed by the startup control means to the control in the fully energized state performed by the normal control means, if the determination means determines that the rotation speed of the motor has reached the threshold.

3. The motor drive control unit according to claim 1, wherein:
the switching element is provided upstream and downstream of a flow of the motor current in the supply path, with the motor being sandwiched between the upstream and downstream switching elements; and
when the automatic braking is applied, the control means causes the startup control means to perform the high frequency control with respect to only one of the upstream and downstream switching elements, and causes the other one of the upstream and downstream switching elements to be continuously turned on from the startup.

4. The motor drive control unit according to claim 1, wherein the startup control means controls, as the high frequency control, a duty ratio obtained when the switching element is turned on/off switching, and sets the duty ratio on the basis of a voltage of the power source.

5. The motor drive control unit according to claim 1, wherein the startup control means controls, as the high frequency control, a duty ratio obtained when the switching element is turned on/off switching, and sets the duty ratio on the basis of a temperature of the power source.

6. The motor drive control unit according to claim 2, wherein the determination means corrects the rotation speed of the motor according to a temperature of the motor and determines whether the rotation speed thus corrected has reached the threshold.
